(19) United States
(12) Patent Application Publication
(10) Pub. No.: US 2002/0118439 A1
(43) Pub. Date: Aug. 29, 2002

(54) Optical frequency synthesizing structure

(75) Inventor: Robert G. Batchko, Stanford, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Lightbit Corporation, Mountain View, CA (US)

(21) Appl. No.: 09/991,460

(22) Filed: Nov. 16, 2001

Related U.S. Application Data
(60) Provisional application No. 60/249,569, filed on Nov. 16, 2000.
(60) Provisional application No. 60/281,148, filed on Apr. 2, 2001.

(51) Int. Cl. G02F 1/35; G02F 1/365; G02F 1/37

(52) U.S. Cl. 359/326; 359/328; 359/332

(57) ABSTRACT

An Optical Frequency Shifter (Shifter) enables all-optical frequency translation to be imparted on a data-carrying Input Optical Signal (Input Signal). The Shifter includes a first difference-frequency-mixer for achieving quasi-phase-matching between a first pump channel, the Input Signal and an Intermediate Signal. A second difference-frequency-mixer is employed for achieving quasi-phase-matching between a second pump signal, the intermediate signal and a converted signal. A frequency shift discriminates the input signal from the output signal wherein the value of the frequency shift is proportional to the difference in frequencies of the first pump signal and the second pump signal. In this fashion, the value of the frequency shift in independent of the frequency of the input signal. A multiple of Input Signals may be coupled into the Shifter and may be simultaneously shifted to a multiple of respective converted signals wherein the frequency shift has a constant value and discriminates each input signal from each respective converted signal. The Shifter may employ cascaded second harmonic generation (SHG) and difference frequency generation (DFG) thereby enabling the use of pump sources having frequencies generally in the proximity of the frequencies of the Input Signal and Converted Signal. In this fashion, first and second sub-harmonic pump signals may be quasi-phase-matched by the Shifter for achieving SHG thereby generating said first and second pump signals.

A plurality of Shifters may be coupled to each other, thereby enabling a plurality of frequency translations to be imparted on the Input Signals.

### CROSS-REFERENCES TO RELATED APPLICATIONS

This application claims the benefit of provisional Application Nos. 60/249569, filed Nov. 16, 2000, entitled “Optical Frequency Synthesis,” (Atty Dckt 20882-000100) and 60/281,148, filed Apr. 02, 2001, entitled “Any-to-Any Wavelength Converter,” (Atty Dckt 20882-001600) the disclosures of which are incorporated herein by reference.

### BACKGROUND OF THE INVENTION

WDM. ITU

Wave Division Multiplexing (WDM) represents a major fiber-optic revolution by multiplying the communication bandwidth of optical fibers. In WDM, multiple optical carriers, at different wavelengths of light, each carry signals over the same fiber. The number of carriers for each fiber has increased over the years from 4, to 8, to 16 (the 16-wavelength technique is known as “dense” WDM). The Dense WDM standard is defined by the International Telecommunications Union (ITU) and defines channels having a frequency separation of 100 GHz. The ITU grid of frequencies is depicted in FIG. 1. The various channels are displaced from the base of the grid, at the frequency of 193,100 GHz, or about 1552.52 nm, and the grid separation is 100 GHz, or 0.8 nm. Typical ITU spectra include the C-band, ranging from approximately 1530 to 1560 nm, and the L-band, ranging from approximately 1570 to 1600 nm.

Wavelength Conversion, Blocking

An important component of a WDM network is a wavelength converter (references). As described above, a signal carrying information is typically modulated onto an optical carrier frequency that is defined on the ITU grid. Wavelength converters are utilized to change the signal modulated on one optical carrier frequency to another carrier frequency on the ITU grid. One example of the need for wavelength conversion is for the elimination of blocking. Blocking, as known on optical communications, is an interferometric effect that degrades the quality of signals. Blocking occurs when, for example, two signals having substantially identical optical carrier frequencies, and originating from different locations, arrive at a common network node. The two signals may then need to be switched into the same fiber to in order to be directed to their respective destinations. However, without controlling the phase of at least one of the signals, the information carried by the signals may be subject to corruption by optical interference or blocking. Accordingly, a wavelength converter may be utilized to shift the carrier frequency of one of the signals to an alternative frequency so that both signals may be transmitted by the same fiber without the occurrence of blocking. Additionally, wavelength converters can be utilized to provide network inter-operability. In enabling such network inter-operability, a wavelength converter may be utilized to change the optical carrier frequency of a given signal from a frequency supported by a first network to a different frequency supported by a second network.

OPM, Alternative Techniques to Wavelength Conversion

Wavelength converters are known in the art and one technique for implementing wavelength conversion, optical frequency mixing (ref), is based on the physics of nonlinear optics. One approach to nonlinear-optics-based wavelength conversion, four-wave mixing (FWM), utilizes the χ⁽³⁾ nonlinear optical susceptibility in a nonlinear optical material. In certain wavelength conversion applications, FWM is known to suffer from effects such as low conversion efficiency and the generation of unwanted sidebands. An alternative approach to FWM, quasi-phase-matching (QPM), utilizes the χ⁽²⁾ nonlinear optical susceptibility and the dispersion properties of a material in order to achieve interactions involving the mixing of three waves, or “three-wave mixing” (TWM). The advantages of QPM-based wavelength converters over FWM and other approaches include orders-of-magnitude higher conversion efficiency and the ability to tailor the performance characteristics of devices in aspects such as bandwidth, dispersion, group velocity mismatch and spectral inversion.

In QPM, the sign of χ⁽²⁾ in the nonlinear optical material is periodically reversed, thereby providing a periodic grating comprising alternating flipped domains in the material. In this fashion, the periodic grating provides a mechanism for the compensation of k-vector mismatch, due to dispersion in the material, among the interacting optical waves. One nonlinear optical material, periodically-poled lithium niobate (LiNbO₃) (PPLN), is known to be advantageous for use in QPM applications due to its high nonlinear conversion efficiency, flexibility and ease in the formation of periodic domains, low optical loss through visible and infrared wavelengths, flexibility and ease in the formation of optical waveguide structures, and the relatively low cost and availability of LiNbO₃ substrates.

Difference Frequency Mixing

In the QPM nonlinear optical process, difference frequency mixing (DFM), input waves at frequencies ωₚ and ωₛ are mixed thereby generating a converted output frequency ω_{c} where the relationship between the frequencies of the three interacting waves is given by eq. 1:

ω_{c}=ωₚ−ωₛ. (eq. 1)

This presents an approach to achieving a wavelength converter utilizing TWM and QPM. However, the dependence of ω_{c} on ωₛ in TWM processes as expressed in eq. 1, limits the usefulness of three-wave mixers from achieving any-to-any wavelength conversion.

Multiple Pump/Low Conversion Efficiency Problem

The output power Pₒᵤₜ of a TWM DFM mixer is generally related to the pump power Pₚ and the signal power Pₛ as given by eq. 2

Pₒᵤₜ=ηPₚPₛ. (eq. 2)

In QPM waveguide devices, the nonlinear conversion efficiency η, [% W⁻¹] is generally proportional to the square of the length of the device and to the spatial overlap of the pump, signal, and output modes. For a QPM DFM device having a generally uniform grating period, the spectral acceptance bandwidth of the pump frequency is inversely proportional to the length of the QPM grating. This relationship typically leads to narrow acceptance bandwidths. For example, in practice, a typical pump acceptance bandwidth achieved for a 5-cm long QPM lithium niobate proton exchanged waveguide device is typically about 0.1- to about 0.2 nm for pump wavelengths in the range of about 1.5 μm.

The Problems with Multiple Channel Converters/Single Stage dfg

In WDM wavelength conversion applications, it is often desirable that the wavelength converter device be capable of performing multiple frequency shifts on the optical signal. In this fashion, the wavelength converter should therefore be capable of generating multiple converted output signals from a given input signal. Fejer et. At [REF cite] presented such Multiple Channel Optical Frequency Mixer (check title or different title?) in which an input signal channel, transmitted into the mixer, could be shifted to a number of output converted channels. In the system described therein, the number of frequency shifts that may be performed on a given signal frequency is equal to the number of discrete optical pump frequencies utilized by the device. However, problems with devices based on this approach include: a reduction in conversion efficiency, and an increase in complexity of both the device architecture and the pump sources, as the number of obtainable frequency shifts increases to large values.

The Need for Any-to-Any Wavelength Conversion

While the above-mentioned techniques achieve wavelength conversion, they only provide solutions that are practical for generating a limited number of wavelength-converted signals, and therefore, can only provide partial non-blocking. An ideal wavelength converter should provide full non-blocking capability to the optical network. Generally, this can be achieved only if the wavelength converter is capable of receiving an input signal, having a frequency at any channel on the ITU grid, and converting it to an output signal having a frequency at any other channel on the grid. This universal capability is known as ‘any-to-any” wavelength conversion and such a device is referred to as an Any-To-Any Wavelength Converter.

Spectral Inversion Problem

Another factor generally limiting the functionality of TWM in achieving an any-to-any wavelength converter is the effect of spectral inversion. [Pat Ref] presents a wavelength converter having the property of spectral inversion. While, as will be described below, such devices may derive benefits in applications including fiber dispersion compensation, their approach is not suitable toward achieving an any-to-any wavelength converter.

FIGS. 2A and 2B depict the function of a typical TWM wavelength converter, utilizing the nonlinear process DFM, as could be applicable toward the ITU WDM frequency grid. As known in nonlinear optics, the frequency 0.5ωₚ is equal to one-half of the pump frequency and is commonly referred to as the sub-harmonic pump frequency (Sub-harmonic). As is also understood in nonlinear optics, the DFM condition at which ωₛ=ω_{c} is known as degeneracy. Therefore, by eq. 1, for the case of DFM at degeneracy, the frequencies of the signal, converted and Sub-harmonic waves are equal; i.e., at degeneracy, ωₛ=ω_{c}=0.5ωₚ.

As illustrated in FIG. 2A, ωₛ is displaced from 0.5ωₚ by an off-degeneracy frequency δω and therefore, based on eq. 1, ω_{c} is similarly displaced from 0.5 ωₚ by-δω. These relationships between δω and the interacting waves are further expressed in eqs. 3 and 4, below,

ωₛ=0.5ωₚ+δω (eq. 3)

ω_{c}=ωₚ−(0.5ωₚδω)=0.5ωₚ−δω. (eq. 4)

In this fashion, and as illustrated in FIG. 2A, ω_{c} and ωₛ are spectrally mirrored about 0.5ωₚ by δω. Therefore, as can be calculated from eqs. 4 and 5, ω_{c} and ωₛ are displaced from one another by a difference frequency 2δω,

ωₛ−ω_{c}=2δω (eq. 5)

It is known by those skilled in the art that DFM-based nonlinear optical wavelength converters are capable of simultaneously converting multiple signals about a Sub-harmonic. FIG. 2B illustrates how a conventional DFM wavelength converter may affect a plurality of input signals, ω_{s,1 . . . n}, where ω_{s,1 . . . n} comprises a plurality of unique optical frequency components and has a spectral power distribution. Since each optical frequency component in ω_{s,1 . . . n} is unique, each will likewise be displaced from 0.5ωₚ by a corresponding unique δω_{1 . . . n}. Therefore, similar to spectral mirroring for individual ωₛ and ω_{c} frequencies about 0.5ωₚ as illustrated in FIG. 2A, the unique δω_{1 . . . n} corresponding to each respective frequency component of ω_{s,1 . . . n} results in the spectral mirroring of each of the respective frequency components of ω_{s,1 . . . n} and ω_{c,1 . . . n} about 0.5ωₚ. Additionally, each unique frequency component of ω_{s,1 . . . n} and each corresponding frequency component of ω_{c,1 . . . n} are separated by a unique difference frequency 2δω_{s,1 . . . n}. Such multiple-frequency spectral mirroring is known in the art as Spectral Inversion and is depicted in FIG. 2B. Spectral inversion can similarly be utilized in ultrafast optics to spectrally invert the spectrum and envelope of ultrafast optical pulses having spectral power distributions and typical pulsewidths in the range of 10⁻¹⁰ seconds or less. Spectral inversion has been utilized in χ⁽²⁾-based DFM wavelength converters in order to overcome linear and nonlinear dispersion in optical fiber. Such devices include midspan spectral inverters and Kerr effect compensators.

Need for Non-spectral Inverting Wavelength Conversion

However, while DFM-induced spectral inversion can be useful in applications such as dispersion compensation as described above, it can also limit the usefulness of devices used in wavelength conversion applications. For example, as illustrated in FIG. 2C, it may be desirable in certain applications to perform a uniform frequency shift on a plurality of input signals, ω_{s,1 . . . n}. In this fashion, it may desired that the respective frequency components of ω_{s,1 . . . n} and ω_{c,1 . . . n} be displaced from one another by a common frequency shift Δω.

While DFM in QPM three-wave mixers has been explored for wavelength conversion applications as described above, the effect of spectral inversion has limited its utilization toward a practical solution for achieving uniform frequency shifts simultaneously over one or more optical wavelengths. Other methods, however, are known in the art for achieving such simultaneous uniform optical frequency shifting; these methods involve the use of Doppler shifting, phase modulation, and FWM. Doppler shifts on the order of 100 MHz are typically achieved using acousto-optic frequency shifters, while electro-optic phase modulators typically obtain frequency shifts on the order of 10 to 50 GHz between the optical carrier and generated sidebands. While acousto- and electro-optic frequency shifting devices can perform simultaneous uniform frequency shifts over a number of optical signals, the typical value of frequency shifts obtainable by these techniques is small in comparison to the spectrum of typical optical communications bands. For example, the C-band, which extends from 1530 to 1570 nm, has a spectrum of approximately 3.4 THz. Raman shifters, having typical gain bandwidths on the order of 10 THz, can obtain much larger frequency shifts than those obtainable by acousto- or electro-optic methods. However, Raman shifting suffers from detrimental effects including Raman-induced crosstalk, cross-phase modulation, soliton self-frequency shift processes and FWM low conversion efficiency.

The effect of spectral inversion is just one problem that limits the usefulness of conventional χ⁽²⁾-based DFM in wavelength conversion applications.

Another approach to wavelength conversion is Wavelength Shifting, which utilizes a sequence of DFM stages.

Another approach to conventional DFM-based wavelength conversion is Any-To-Any Wavelength Conversion, which utilizes a number of optical translation stages where the translation for each stage, Δ, is independent of the frequency of the signal. A number of stages are coupled together to generate various frequencies in the grid. Typically, the number of converted signals generated for each input signal is proportional to the number of pump signals provided. Thus, the number of converted signals is limited by the availability of pump signals.

Accordingly, it is desirable to provide wavelength converters capable of performing conversions across multiple frequencies on the ITU grid, and which are capable of doing so without spectrally inverting the converted signals.

### BRIEF SUMMARY OF THE INVENTION

The present invention provides systems, apparatus and methods for performing optical frequency conversion. An optical frequency shifter (OFS) enables all-optical frequency translation to be imparted on a data-carrying input optical signal (input signal). The OFS includes a first difference-frequency-mixer for achieving quasi-phase-matching (QPM) between a first pump channel, the input signal and an intermediate signal. A second difference-frequency-mixer is employed for achieving quasi-phase-matching between a second pump signal, the intermediate signal and a converted signal. A frequency shift discriminates the input signal from the output signal wherein the value of the frequency shift is proportional to the difference in frequencies of the first pump signal and the second pump signal. The value of the frequency shift is independent of the frequency of the input signal. A multiple of input signals may be coupled into the OFS and may be simultaneously shifted to a multiple of respective converted signals wherein the frequency shift has a constant value and discriminates each input signal from each respective converted signal.

The OFS, in one embodiment, uses cascaded second harmonic generation (SHG) and difference frequency generation (DFG) thereby enabling the use of pump sources having frequencies in between, and generally in the proximity of, the frequencies of the Input Signal and Converted Signal. In this fashion, first and second sub-harmonic pump signals may be quasi-phase-matched by the OFS for achieving SHG thereby generating the first and second pump signals.

In another embodiment, the OFS utilizes pump sources at frequencies sufficient for directly performing DFG without the need to perform cascaded SHG-DFG.

The value of the frequency shift may be tuned using structures and techniques such as multi-channel quasi-phase-matching structures, tunable pump sources, electro-optically or acousto-optically tuned quasi-phase-matching structures, electro-optic phase shifting, thermal control of the QPM device, acousto-optic frequency shifting and third-order nonlinear effects. The OFS is capable of reconfiguration on time scales appropriate for WDM network transmission. The OFS in various embodiments includes apparatus for achieving polarization insensitivity of the Signals, includes apparatus for overcoming group velocity mismatch of ultra-fast pulses, includes filter apparatus for discriminating between converted and non-converted Signals, and may be integrated within optical waveguides.

The present invention also provides any-to-any wavelength converter systems and methods that enable universal all-optical wavelength conversion across the frequency spectra common to optical networks. A converter employs one or more optical frequency shifter (OFS) stages, wherein each stage receives input data-carrying signals and generates converted signals. The converted signals carry the data of respective input signals and are frequency-shifted from input signals by a frequency shift having a value 2ⁿΔω where n is an integer and increases by the value one for each successive stage. One or more coupling apparatus (couplers) may be employed to link the stages, such that converted signals of selected stages may act as the input signals to successive selected stages. In this fashion, a multiple of accumulated frequency shifts may be performed on the input signal(s). The couplers may be dynamically reconfigured, so that the sum value of the accumulated shifts (total shift) may be actively controlled. In this fashion, the number of possible combinations of total shift may be an exponential function of the number of stages. The converter is tunable, capable of reconfiguration on time scales appropriate for WDM network transmissions, includes apparatus for achieving polarization insensitivity of the signals, includes apparatus for overcoming group velocity mismatch of ultra-fast pulses, includes filter apparatus for discriminating between converted and non-converted Signals, and may be integrated within optical waveguides.

According to an aspect of the present invention, an optical frequency shifter (OFS) is provided. The OFS typically includes a first stage including a first nonlinear optical material having a first effective nonlinearity, and a second stage including a second nonlinear optical material having a second effective nonlinearity. The first effective nonlinearity has a first spatial distribution in said first nonlinear optical material such that a first nonlinear optical interaction is achieved between a first pump channel having a first pump frequency, a signal channel having a signal frequency, and an intermediate channel having an intermediate frequency. The second effective nonlinearity has a second spatial distribution in said second nonlinear optical material such that a second nonlinear optical interaction is achieved between a second pump channel having a second pump frequency, said intermediate channel and a converted channel having a converted frequency, such that a shift frequency differentiates the signal frequency from the converted frequency.

According to another aspect of the present invention, an optical frequency shifter is provided that typically includes a plurality of N optical frequency translation stages, with each optical frequency translation stage indexed by an integer n, n=0, . . . N, and with each optical frequency translation stage having an input port, and an output port, with the optical frequency translation stage for receiving an input signal at the input port and for translating a received input signal into a translated output signal provided by the output port, with the translated output signal having a frequency equal to an input signal frequency translated by a frequency equal to 2n Δ, where Δ is a frequency shift having a selected value; and an input signal coupling structure for coupling the input port of an nth optical frequency translation stage to the output ports of all optical frequency translation stages preceding the nth optical stage.

According to another aspect of the present invention, a method is provided for synthesizing a plurality of optical frequencies. The method typically includes receiving an input signal having an input signal frequency, performing a first translation of a frequency shift of Δ on the input signal to generate a first translated signal having a frequency translated from the input signal frequency by Δ, and performing a second translation of a frequency shift of 2Δ on both the input signal and the first translated signal to generate second and third translated signals translated from the input signal frequency by 2Δ and 3Δ. The method also typically includes sequentially performing n subsequent translations, n being an integer equal to 3, . . . , N, with the nth translation translating the frequency of the input signal and all previously generated translated signals by a frequency shift of 2ⁿΔ to generate 2ⁿ translated signals translated from the input signal frequency by nΔ, n+1Δ, n+2Δ, . . . , 2ⁿ−2Δ, 2ⁿ−1Δ.

According to another aspect of the invention, an OFS Module is capable of achieving an optical frequency shift, Δω, between ωₛ and ω_{c}, where Δω is proportional to the difference in frequencies between two pump sources.

According to another aspect of the invention, an OFS Module is capable of achieving an optical frequency shift, Δω, that is independent of the frequency of the input signal.

According to one aspect of the invention, an OFS structure is capable of generating 2ⁿ translated frequencies based on a single input frequency while using only n translation stages and (n+1) pump signals at different frequencies.

According to another aspect of the invention, the requirements of non-linear phase matching are reduced including the number of different quasi-phase matching periods of QPM gratings.

According to another aspect of the invention, the pump frequencies are selected so that the frequency difference generated at each stage is twice the frequency difference generated by a previous phase.

According to another aspect of the invention, an OFS stage includes a first part for mixing a first pump signal with the input signal to form a first part output signal and a second part for mixing the first part output signal with a second pump signal to form an OFS stage output signal.

According to another aspect of the invention, an OFS stage includes a first part for forming a second harmonic of a first pump signal, mixing the second harmonic of the first pump signal with the input signal to form a first part output signal and a second part for forming the second harmonic of a second pump signal, and mixing the first part output signal with the second harmonic of the second pump signal to form an OFS stage output signal.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 is a graph depicting an ITU WDM signal grid;

FIG. 2A is a graph depicting frequency shifting a signal about a single pump frequency;

FIG. 2B is a graph depicting generating a series of converted signals from one signal;

FIG. 2C is a graph depicting a series of converted signals with a common frequency shift;

FIG. 3 is a diagram of an embodiment of an OFS structure;

FIG. 4 is a diagram of a second embodiment of an OFS structure;

FIG. 5 is a diagram of an OFS structure utilizing serpentine-shaped waveguides for light coupling;

FIG. 6 is a diagram of an OFS structure utilizing a single “u” shaped bend in a waveguide for light coupling;

FIG. 7 is a diagram of an OFS structure utilizing a double bend in a waveguide for light coupling;

FIG. 8 is a diagram depicting a first embodiment of an OFS frequency shifting stage;

FIG. 9 is a diagram depicting a second embodiment of an OFS frequency shifting stage;

FIG. 10 illustrates frequency shifting for a range of input signals;

FIG. 11 illustrates frequency shifting including generating sub-harmonics of the first and second pump signals; and

FIG. 12 illustrates a block diagram of a optical frequency shifter (OFS) according to an embodiment of the present invention.

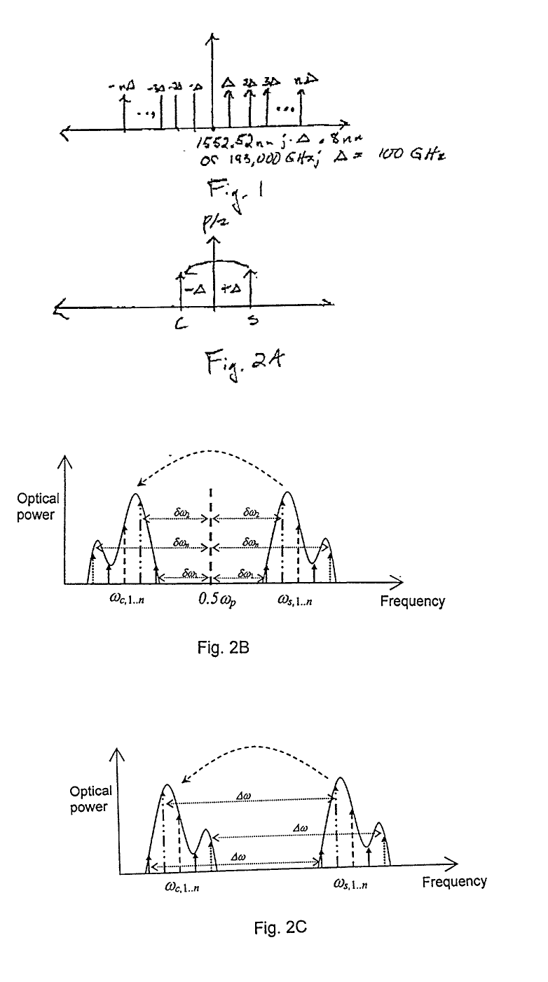

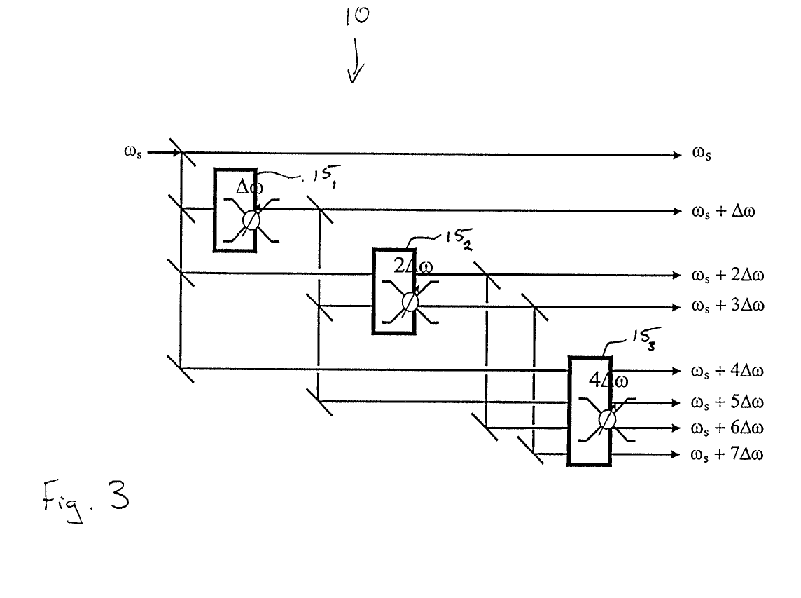

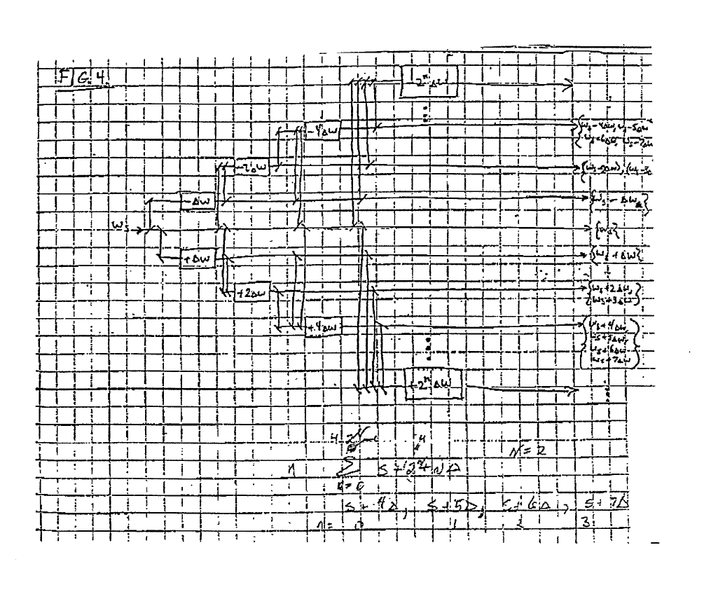

### DETAILED DESCRIPTION OF THE INVENTION

The invention will now be described with reference to the appended drawings. FIG. 3 depicts an embodiment of an OFS structure 10 of the invention that reduces the number of pump frequencies required to translate an optical signal to a grid of converted signals at different frequencies. For simplicity, Δω, ωₛ, ω_{c}, and ωₚ will be referred to hereinafter as Δ, s, c and p, respectively.

As depicted in FIG. 3, an input signal, s, is coupled to the input of each wavelength conversion stage 15 of the OFS system. Additionally, the input of an Nth stage is coupled to receive the output of all previous stages (n<N). Each output signal is partially coupled to the inputs of following stages by couplers which may be beam splitters such as mirrors, a switch, other optical element such as an evanescent waveguide coupler, or other couplers well-known in the art.

As depicted in FIG. 3, the output of the OFS structure 10 includes the unaltered input signal s. The output of the first stage 15₁ is s+Δ since its only input is s. The possible outputs of the second stage 15₂ are s+2Δ, and s+3Δ, since its inputs are s and s+Δ, and the possible outputs of the third stage 15₃ are s+4Δ, s+5Δ, s+6Δ, and s+7Δ, since the inputs are s, s+Δ, s+2Δ and s+3Δ.

In general, the Nth stage has 2^{N} outputs where the outputs can be calculated as follows:

$$outputs = {\sum }_{n = 0}^{{2}^{N} - 1} s + ( {2}^{N} + n ) Δ ; \qquad ( eq . 6 )$$

The details of an embodiment for implementing the wavelength conversion stages will be described more fully below.

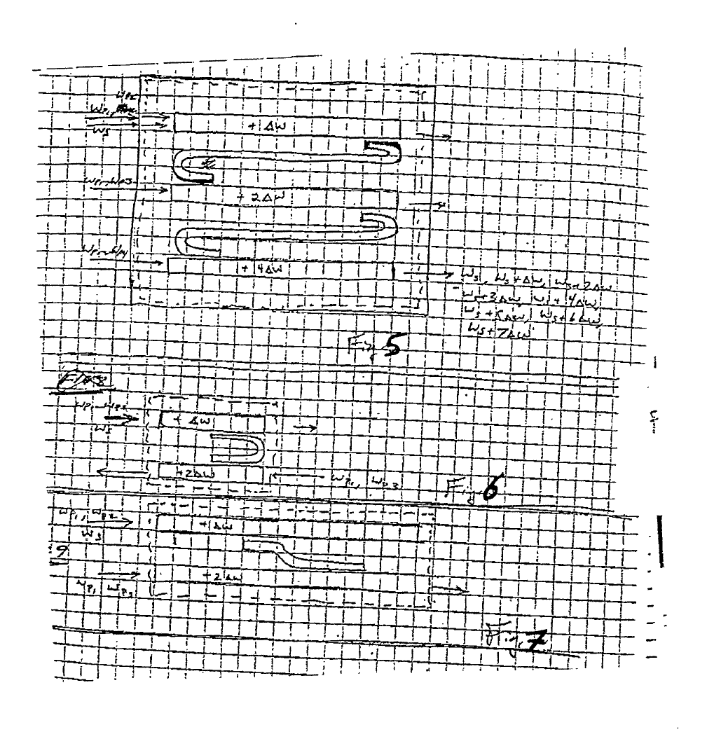

FIG. 4 depicts another embodiment for implementing an OFS system which is similar to the system of FIG. 3 except that frequency conversion stages implementing frequency shifts of ±2ⁿΔ are included. The coupling for positive and negative shifting parts of system are the same as described above with respect to FIG. 3.

The cascading stages of the OFS system depicted in FIGS. 3 and 4 may be implemented monolithically on a single substrate or as a combination of discrete devices. In the system depicted in FIGS. 3 and 4, the multiple OFS stages may be incorporated into a single substrate. The substrate may include non-linear optical waveguides, such as PPLN structures, semiconductors such as GaAs, silicon, polymer plastic organics, or other optical materials. Light may be coupled between the individual OFS stages by coupled waveguides, evanescent coupling, waveguide junctions, bends in waveguides, mirrors, Bragg reflectors, circulators, nonlinear optics, index of refraction gradients, electro-optics, acousto-optics, MEMS, or other techniques known in the art. Waveguides according to various embodiments of the present invention can include buried and surface waveguides, annealed proton exchange (APE) waveguides, proton exchange waveguides, zinc in-diffused waveguides, titanium in-diffused waveguides and others as are well known. Additionally, couplers, directional couplers, junctions, mode filters, tapers, segmentations, bends, etc. as are well know can be implemented to couple various waveguide structures and components.

FIG. 5 is a depiction of an OFS system utilizing serpentine shaped curved waveguides. Note that the outputs of each stage are coupled to following stages and the pumps are fed to each stage.

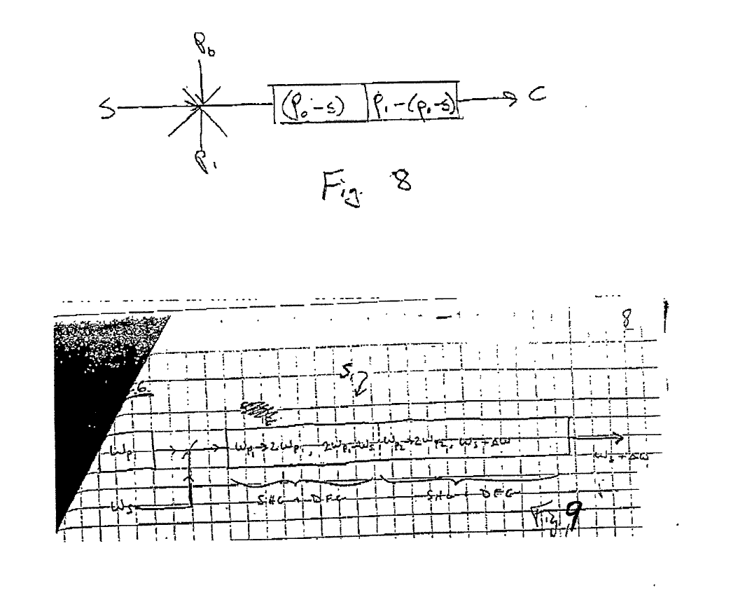

FIG. 6 depicts an OFS using a single “u” shaped bend in a waveguide to couple the output signal from one stage to the input signal of a second stage.

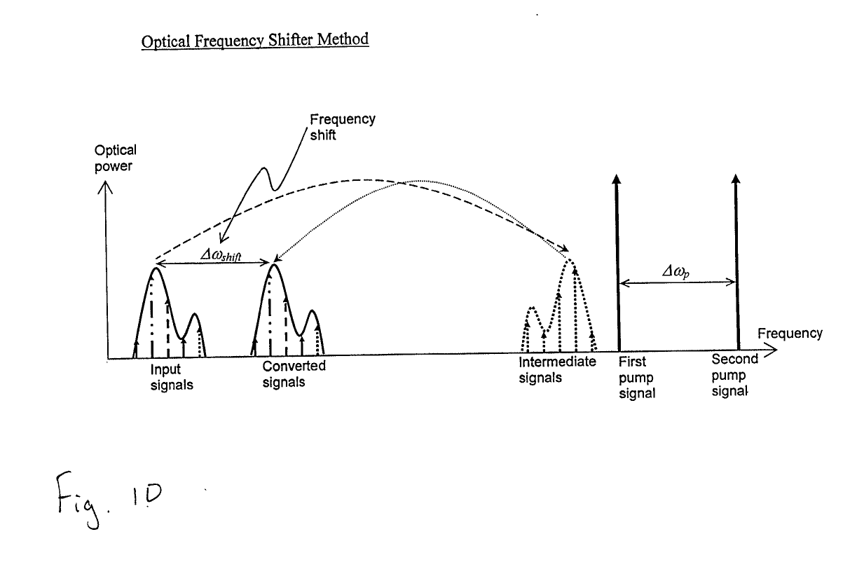

FIG. 7 depicts an OFS using a double bend in a waveguide to couple the output signal from one stage to the input signal of a second stage.

In FIGS. 5 and 7, the direction of the propagation of light is maintained. In FIG. 6 it may be reversed.

FIG. 8 depicts an embodiment of an OFS stage that may be used in the OFS structure 10 described above or used in other applications requiring an OFS stage. The OFS stage frequency shifts an input signal by a frequency shift which is independent of the frequency of the input signal. As described above, in dense WDM the pump frequency is about twice the signal frequency, or equivalently, the pump wavelength (780 nm.) is about half the signal wavelength. In one embodiment, a pump wavelength of 780 nm. is utilized and mixed directly with the input signal. In a second embodiment, a pump wavelength of 1550 nm., equal to the signal wavelength, is utilized. It should be appreciated that other wavelenghts may be used as desired.

The first embodiment, where the pump signal frequency is twice the signal frequency, will now be described. Two pump signals, p0 and p1, are applied to a first mixing stage, which can be a PPLN structure as described above. The pump p0 is mixed to form an intermediate signal at (p0-s1) which is mixed with p1 to form at output signal c1:

c1=p1−(p0−s1)=s1+(p1−p0)=s1+Δ₁ (eq. 7)

where Δ₁ is equal to (p1-p0). Thus, the value of Δ₁ is determined by the pump frequencies, p0 and p1. FIG. 10 illustrates such frequency shifting for a range of input signals, where Δ₁=Δωₚ=Δω_{shift}.

The second OFS stage which mixed its input signal, s2, with p2 and p0 to generate the output signal:

c2=p2−(p0−s2)=s2+(p2−p0)=s2+Δ₂ (eq. 8)

In the OFS structure described above, each stage induces a frequency shift of double the magnitude of the previous stage. Thus, if Δ₂=2Δ₁ then the magnitude of p2 is determined by:

p2−p0=2Δ₁ (eq. 9)

which implies that:

p2=p0+2Δ₁ (eq. 10)

in general for the nth stage:

pₙ=2ⁿ⁻¹Δ₁+p0 (eq. 11)

In the above equations all symbols refer to the frequency of the indicated signal

Thus, by providing pump signals p0 and Pₙ (as determined by eq. 11), each OFS stage generates a frequency difference equal to 2ⁿΔ₁, as required by the OFS system described above with reference to FIGS. 3 and 4.

In the second embodiment, a pump signal having a wavelength of 1550 nm. is provided to each OFS stage. Using this pump frequency has several advantages in that the frequency is available from standard Telco sources and is more easily coupled into the stage. It should be appreciated that other wavelengths may be used as desired for the particular application.

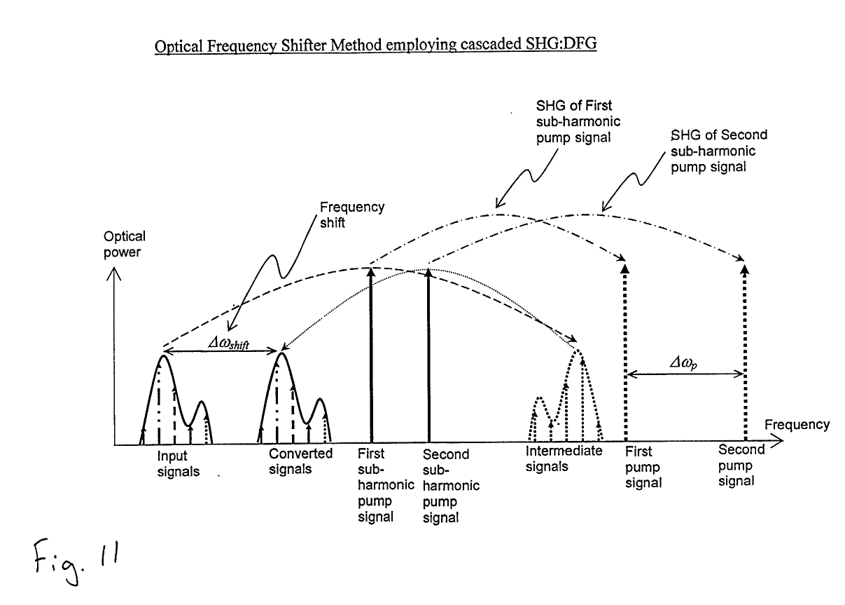

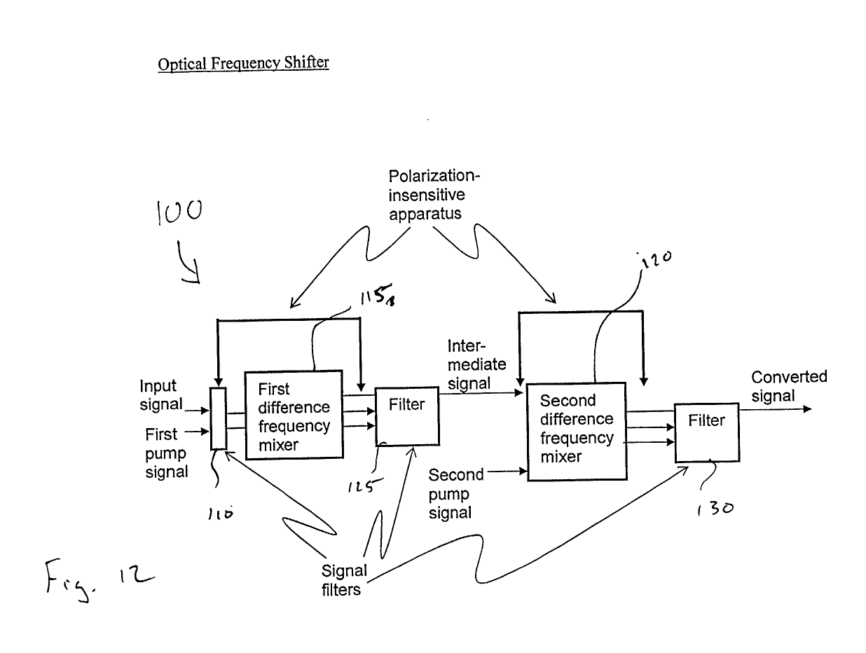

Thus, the pump frequency is the same as the signal frequency so that the pump frequency must be doubled to meet the requirement the s=p/2. This doubling is accomplished utilizing the structure of FIG. 9. The grating that performs DFG also performs SHG (second harmonic generation) of the pump signal to generate the pump at double the frequency of the signal. Thus, as depicted in FIG. 9, a structure for cascading SHG then DFG (“χ⁽²⁾:χ⁽²⁾”, or “SHG:DFG”) in the same grating. FIG. 11 illustrates frequency shifting including generating second harmonics of the first and second pump signals.

The OFS stage in FIG. 9 includes two stages, a first stage having a grating tuned to double the first pump signal and mix the doubled first pump signal with an input signal to form an intermediate mixed signal, and a second stage having a grating tuned to double the second pump signal and to mix the doubled second pump signal with the intermediate mixed signal to form an output signal of frequency:

c1=s1+(2p1−2p0)=s1+Δ₁ (eq. 12)

where Δ₁=2(p1−p0).

FIG. 12 illustrates a block diagram of a optical frequency shifter (OFS) 100 according to an embodiment of the present invention. As shown, the input signal and first pump signal are provided to a first stage 115 where the intermediate signal is produced as above. The intermediate signal is then provided along with a second pump signal to a second stage 120 where the converted signal is produced as above. Optional signal filters 110, 125, and 130 are provided for removing unwanted signals as is well known.

If the second embodiment is used in the OFS structure described above, the magnitudes of the pump signals are adjusted to take into account that the pump frequencies have been doubled. With this adjustment eq. 11 is transformed to:

pₙ=½(2ⁿ⁻¹Δ₁)+p0 (eq. 13).

The structures depicted in FIGS. 8 and 9 are particularly suitable to the OFS system described above but are also generally useful in other optical processing applications. QPM electric-field-poled gratings in lithium niobate, lithium tantalite, magnesium-doped lithium niobate and other nonlinear materials may be utilized in the structures. Further, the structures may be composed of discrete components, such as individual PPLN chips separated by couplers and filters. Alternatively, the structures may be integrated within a single substrate such as a PPLN waveguide with portions of integrated devices such as directional couplers, mode filters and tapers.

The invention has now been described with reference to the preferred embodiments. Alternatives and substitutions will now be apparent to persons of skill in the art. For example, the DFG converter described is a PPLN waveguide. However other DFG converters and waveguide conversion devices can be utilized. Additionally, the quasi-phase matching structures of the present invention can include, or be coupled to, difference frequency mixers, sum frequency mixers, optical parametric amplifiers, optical parametric generators, second harmonic generators, Fourier synthetic gratings, chirped gratings, etc, as are well know. Accordingly, it is not intended to limit the invention except as provided by the appended claims.

What is claimed is:

1. An optical frequency shifter capable of performing all-optical frequency translation comprising:
a first stage including a first nonlinear optical material having a first effective nonlinearity; and
a second stage including a second nonlinear optical material having a second effective nonlinearity;
said first effective nonlinearity having a first spatial distribution in said first nonlinear optical material such that a first nonlinear optical interaction is achieved between a first pump channel having a first pump frequency, a signal channel having a signal frequency, and an intermediate channel having an intermediate frequency;
said second effective nonlinearity having a second spatial distribution in said second nonlinear optical material such that a second nonlinear optical interaction is achieved between a second pump channel having a second pump frequency, said intermediate channel and a converted channel having a converted frequency;
such that a shift frequency differentiates said signal frequency from said converted frequency.

2. The optical frequency shifter of claim 1, further comprising one or more couplers for coupling at least a portion of said signal channel, said first pump channel, said intermediate channel, said second pump channel and said converted channel between said first stage and said second stage.

3. The optical frequency shifter of claim 1, further comprising one or more couplers for coupling at least a portion of said signal channel, said first pump channel, said intermediate channel, said second pump channel and said converted channel into and out of said first stage and said second stage.

4. The optical frequency shifter of claim 1, wherein at least a portion of each of said first spatial distribution and said second spatial distribution includes one or more quasi-phase-matching gratings.

5. The optical frequency shifter of claim 1, wherein at least a portion of said first nonlinear optical interaction and said second nonlinear optical interaction are second order nonlinear optical interactions.

6. The optical frequency shifter of claim 1, wherein at least a portion of said first nonlinear optical interaction and said second nonlinear optical interaction are quasi-phase-matched nonlinear optical interactions.

7. An optical frequency shifter, comprising:
a first nonlinear optical material having a first quasi-phase-matching structure; and
a second nonlinear optical material having a second quasi-phase-matching structure;
said first quasi-phase-matching structure configured such that a first quasi-phase-matched interaction is achieved between a first pump channel having a first pump frequency, a signal channel having a signal frequency, and an intermediate channel having an intermediate frequency;
said second quasi-phase-matching structure configured such that a second quasi-phase-matched interaction is achieved between a second pump channel having a second pump frequency, said intermediate channel, and a converted channel having a converted frequency;
such that a shift frequency differentiates said converted frequency from said signal frequency.

8. The optical frequency shifter of claim 7 wherein said frequency shifting is performed simultaneously on a plurality of signal channels having a plurality of signal frequencies thereby generating a plurality of intermediate channels having a plurality of intermediate frequencies and a plurality of converted channels having a plurality of converted frequencies.

9. The optical frequency shifter of claim 7 wherein said shift frequency is independent of said signal frequency.

10. The optical frequency shifter of claim 7 wherein said shift frequency is independent of said plurality of signal frequencies.

11. The optical frequency shifter of claim 7 wherein said first and second quasi-phase-matching structures are configured such that said shift frequency is a function of said first pump frequency and said second pump frequency.

12. The optical frequency shifter of claim 7 wherein said first and second quasi-phase-matching structures are configured such that said shift frequency is defined as the difference between said first pump frequency and said second pump frequency.

13. The optical frequency shifter of claim 7, wherein said first and second quasi-phase-matching structures are configured such that said shift frequency is defined as twice the difference between said first pump frequency and said second pump frequency.

14. The optical frequency shifter of claim 7, further comprising an optical filter for discriminating between said signal channel and said converted channel.

15. The optical frequency shifter of claim 8, further comprising an optical filter for discriminating between said plurality of signal channels and said plurality of converted channels.

16. The optical frequency shifter of claim 7, wherein said first quasi-phase-matching structure and said second quasi-phase-matching structure each include one or more of difference frequency mixers, sum frequency mixers, optical parametric amplifiers, optical parametric generators and second harmonic generators.

17. The optical frequency shifter of claim 7, wherein said first quasi-phase-matched interaction includes cascaded second harmonic generation and difference frequency generation.

18. The optical frequency shifter of claim 7, wherein said second quasi-phase-matched interaction includes cascaded second harmonic generation and difference frequency generation.

19. The optical frequency shifter of claim 7 wherein one or both of said first quasi-phase-matching structure and said second quasi-phase-matching structure include a Fourier synthetic grating.

20. The optical frequency shifter of claim 7, wherein one or both of said first quasi-phase-matching structure and said second quasi-phase-matching structure include a chirped grating.

21. The optical frequency shifter of claim 7, wherein one or both of said first quasi-phase-matching structure and said second quasi-phase-matching structure include an apodized grating.

22. The optical frequency shifter of claim 7, wherein one or both of said first quasi-phase-matching structure and said second quasi-phase-matching structure include one or more waveguides.

23. The optical frequency shifter of claim 7, wherein one or both of said first quasi-phase-matching structure and said second quasi-phase-matching structure utilize one or more waveguides for guiding one or more of said first pump channel, said second pump channel, said signal channel, said intermediate channel, and said converted channel.

24. The optical frequency shifter of claim 8 wherein one or both of said first quasi-phase-matching structure and said second quasi-phase-matching structure utilize one or more waveguides for guiding one or more of said first pump channel, said second pump channel, said plurality of signal channels, a plurality of intermediate channels, and said plurality of converted channels.

25. The optical frequency shifter of claim 22, wherein each waveguide includes one or more of zinc in-diffused, titanium in-diffused, proton exchanged, annealed proton exchanged, buried and surface waveguides.

26. The optical frequency shifter of claim 22, wherein each waveguide includes one or more of couplers, directional couplers, junctions, mode filters, tapers, segmentations, and bends.

27. The optical frequency shifter of claim 7 further comprising polarization insensitive apparatus to enable the conversion of signal channels having a plurality of states of electromagnetic polarization.

28. The optical frequency shifter of claim 7, further comprising a coupler for coupling said intermediate channel into said second quasi-phase-matching structure.

29. The optical frequency shifter of claim 7, further comprising an intermediate channel coupler for coupling said intermediate channel from said first quasi-phase-matching structure into said second quasi-phase-matching structure.

30. The optical frequency shifter of claim 7, further comprising a first pump source for providing said first pump channel.

31. The optical frequency shifter of claim 7, further comprising a second pump source for providing said second pump channel.

32. The optical frequency shifter of claim 7, further comprising a signal source for providing said signal pump channel.

33. The optical frequency shifter of claim 7, further comprising one or more acousto-optic frequency shifters for performing at least a portion of said frequency shifting.

34. The optical frequency shifter of claim 7, further comprising one or more electro-optic frequency shifters for performing at least a portion of said frequency shifting.

35. An optical frequency shifter, comprising:
a monolithic nonlinear optical material having a first quasi-phase-matching structure and a second quasi-phase-matching structure;
said first quasi-phase-matching structure configured such that a first quasi-phase-matched interaction is achieved between a first pump channel having a first pump frequency, a signal channel having a signal frequency, and an intermediate channel having an intermediate frequency;
said second quasi-phase-matching structure configured such that a second quasi-phase-matched interaction is achieved between a second pump channel having a second pump frequency, said intermediate channel, and a converted channel having a converted frequency;
such that a shift frequency differentiates said converted frequency from said signal frequency.

36. The optical frequency shifter of claim 35, wherein said frequency shifting is performed simultaneously on a plurality of signal channels having a plurality of signal frequencies thereby generating a plurality of intermediate channels having a plurality of intermediate frequencies and a plurality of converted channels having a plurality of converted frequencies.

37. The optical frequency shifter of claim 35, wherein said shift frequency is independent of said signal frequency.

38. The optical frequency shifter of claim 36 wherein said shift frequency is independent of said plurality of signal frequencies.

39. The optical frequency shifter of claim 35, wherein said first and second quasi-phase-matching structures are configured such that said shift frequency is a function of said first pump frequency and said second pump frequency.

40. The optical frequency shifter of claim 35, wherein said first and second quasi-phase-matching structures are configured such that said shift frequency is defined as the difference between said first pump frequency and said second pump frequency.

41. The optical frequency shifter of claim 35, wherein said first and second quasi-phase-matching structures are configured such that said shift frequency is defined as twice the difference between said first pump frequency and said second pump frequency.

42. The optical frequency shifter of claim 35, further comprising an optical filter for discriminating between said signal channel and said converted channel.

43. The optical frequency shifter of claim 36 further comprising an optical filter for discriminating between said plurality of signal channels and said plurality of converted channels.

44. The optical frequency shifter of claim 35, wherein said first quasi-phase-matching structure and said second quasi-phase-matching structure each include one or more of difference frequency mixers, sum frequency mixers, optical parametric amplifiers, optical parametric generators and second harmonic generators.

45. The optical frequency shifter of claim 35, wherein said first quasi-phase-matched interaction includes cascaded second harmonic generation and difference frequency generation.

46. The optical frequency shifter of claim 35, wherein said second quasi-phase-matched interaction includes cascaded second harmonic generation and difference frequency generation.

47. The optical frequency shifter of claim 35, wherein one both of said first quasi-phase-matching structure and said second quasi-phase-matching structure include a Fourier synthetic grating.

48. The optical frequency shifter of claim 35, wherein one or both of said first quasi-phase-matching structure and said second quasi-phase-matching structure include a chirped grating.

49. The optical frequency shifter of claim 35, wherein one or both of said first quasi-phase-matching structure and said second quasi-phase-matching structure include an apodized grating.

50. The optical frequency shifter of claim 35, wherein one or both of said first quasi-phase-matching structure and said second quasi-phase-matching structure include one or more waveguides.

51. The optical frequency shifter of claim 35, wherein one or both of said first quasi-phase-matching structure and said second quasi-phase-matching structure utilize one or more waveguides for guiding one or more of said first pump channel, said second pump channel, said signal channel, said intermediate channel, and said converted channel.

52. The optical frequency shifter of claim 36 wherein one or more of said first quasi-phase-matching structure and second said quasi-phase-matching structure utilize one or more waveguides for guiding one or more of said first pump channel, said second pump channel, said plurality of signal channels, a plurality of intermediate channels, and said plurality of converted channels.

53. The optical frequency shifter of claim 50, wherein each waveguide includes one or more of zinc in-diffused, titanium in-diffused, proton exchanged, annealed proton exchanged, buried and surface waveguides.

54. The optical frequency shifter of claim 50, wherein each waveguide includes one or more of couplers, directional couplers, junctions, mode filters, tapers, segmentations, and bends.

55. The optical frequency shifter of claim 35, further comprising polarization insensitive apparatus to enable the conversion of signal channels having a plurality of states of electromagnetic polarization.

56. The optical frequency shifter of claim 35, further comprising an intermediate channel coupler for coupling said intermediate channel from said first quasi-phase-matching structure into said second quasi-phase-matching structure.

57. The optical frequency shifter of claim 35, further comprising a first pump source for providing said first pump channel.

58. The optical frequency shifter of claim 35, further comprising a second pump source for providing said second pump channel.

59. The optical frequency shifter of claim 35, further comprising a signal source for providing said signal pump channel.

60. The optical frequency shifter of claim 35, further comprising one or more acousto-optic frequency shifters for performing at least a portion of said frequency shifting.

61. The optical frequency shifter of claim 35, further comprising one or more electro-optic frequency shifters for performing at least a portion of said frequency shifting.

62. An optical frequency shifter, comprising:
a first converter stage capable of performing a first frequency shift; and
a second converter stage capable of performing a second frequency shift;
said first converter stage including a first quasi-phase-matching structure in a first nonlinear optical material, and a second quasi-phase-matching structure in a second nonlinear optical material;
said first quasi-phase-matching structure configured such that a first quasi-phase-matched interaction is achieved between a first pump channel having a first pump frequency, a first signal channel having a first signal frequency, and a first intermediate channel having a first intermediate frequency;
said second quasi-phase-matching structure configured such that a second quasi-phase-matched interaction is achieved between a second pump channel having a second pump frequency, said first intermediate channel, and a first converted channel having a first converted frequency;
said second converter stage including a third quasi-phase-matching structure in a third nonlinear optical material, and a fourth quasi-phase-matching structure in a fourth nonlinear optical material;
said third quasi-phase-matching structure configured such that a third quasi-phase-matched interaction is achieved between a third pump channel having a third pump frequency, a second signal channel having a second signal frequency, and a second intermediate channel having a second intermediate frequency;
said fourth quasi-phase-matching structure configured such that a fourth quasi-phase-matched interaction is achieved between a fourth pump channel having a fourth pump frequency, said second intermediate channel, and a second converted channel having a second converted frequency.

63. An optical frequency shifter, comprising:
a first converter capable of receiving a first signal channel having a first signal frequency and generating a first converted channel having a first converted frequency, wherein a first frequency shift differentiates said first converted frequency from said first signal frequency;
a second converter capable of receiving a second signal channel having a second signal frequency and generating a second converted channel having a second converted frequency, wherein a second frequency shift differentiates said second converted frequency from said second signal frequency; and
a coupling structure for coupling at least a portion of said first signal channel, said second signal channel, said first converted channel and said second converted channel, between said first converter and said second converter.

64. The optical frequency shifter of claim 63 further comprising a plurality of said converters.

65. The optical frequency shifter of claim 63, wherein said first signal channel comprises a plurality of first signal channels having a plurality of first signal channel frequencies, and wherein said first converted channel comprises a plurality of first converted channels having a plurality of first converted channel frequencies.

66. The optical frequency shifter of claim 63, wherein said second signal channel comprises a plurality of second signal channels having a plurality of second signal channel frequencies, and wherein said second converted channel comprises a plurality of second converted channels having a plurality of second converted channel frequencies.

67. The optical frequency shifter of claim 63, wherein said first converter stage further includes:
a first quasi-phase-matching structure in a first nonlinear optical material, and a second quasi-phase-matching structure in a second nonlinear optical material;
said first quasi-phase-matching structure configured such that a first quasi-phase-matched interaction is achieved between a first pump channel having a first pump frequency, said first signal channel, and a first intermediate channel having a first intermediate frequency;
said second quasi-phase-matching structure configured such that a second quasi-phase-matched interaction is achieved between a second pump channel having a second pump frequency, said first intermediate channel, and said first converted channel.

68. The optical frequency shifter of claim 63, wherein said second converter stage further includes:
a third quasi-phase-matching structure in a third nonlinear optical material, and a fourth quasi-phase-matching structure in a fourth nonlinear optical material;
said third quasi-phase-matching structure configured such that a third quasi-phase-matched interaction is achieved between a third pump channel having a third pump frequency, said second signal channel, and a second intermediate channel having a second intermediate frequency;
said fourth quasi-phase-matching structure configured such that a fourth quasi-phase-matched interaction is achieved between a fourth pump channel having a fourth pump frequency, said second intermediate channel, and said second converted channel.

69. The optical frequency shifter of claim 63, wherein said first converter stage further includes an acousto-optic frequency shifter.

70. The optical frequency shifter of claim 63, wherein said second converter stage further includes an acousto-optic frequency shifter.

71. The optical frequency shifter of claim 63, wherein said first converter stage further includes an electro-optic frequency shifter.

72. The optical frequency shifter of claim 63, wherein said second converter stage further comprises an electro-optic frequency shifter.

73. An optical frequency shifter, capable of performing optical frequency shifting, comprising a nonlinear optical material having an effective nonlinearity d_{eff}, and a quasi-phase-matching structure in said nonlinear optical material, such that a first channel and a second channel both quasi-phase-match for performing optical frequency mixing.

74. The optical frequency shifter of claim 73 wherein said optical frequency shifter includes a first difference frequency mixing stage quasi-phase-matched for a first pump channel, and a second difference frequency mixing stage quasi-phase-matched for a second pump channel.

75. An optical frequency shifter, capable of performing frequency shifting on one or more signal channels, comprising a nonlinear optical material having an effective nonlinearity d_{eff}, whereby said effective d_{eff} is spatially distributed in said nonlinear optical material so as to form a quasi-phase-matching structure, wherein two pump channels quasi-phase-match for performing frequency shifting, wherein a resulting frequency translation is a function of the difference in frequencies between said pump channels.

76. An optical frequency shifter comprising:
a plurality of N optical frequency translation stages, with each optical frequency translation stage indexed by an integer n, n=0, . . . N, and with each optical frequency translation stage having an input port, and an output port, with the optical frequency translation stage for receiving an input signal at the input port and for translating a received input signal into a translated output signal provided by the output port, with the translated output signal having a frequency equal to an input signal frequency translated by a frequency equal to 2n Δ, where Δ is a frequency shift having a selected value; and
an input signal coupling structure for coupling the input port of an nth optical frequency translation stage to the output ports of all optical frequency translation stages preceding the nth optical stage.

77. The optical frequency shifter of claim 76 wherein each optical frequency translation stage comprises:
a first stage that receives a first pump signal, generates a second harmonic of the first pump signal, and mixes the second harmonic of the first pump signal with the input signal to generate a first stage output signal; and
a second stage that receives a second pump signal, generates a second harmonic of the second pump signal, and mixes the second harmonic of the second pump signal with the first stage output signal to generate an OFS stage output signal.

78. The optical frequency shifter of claim 76 wherein each optical frequency translation stage comprises:
a first stage that receives a first pump signal, and mixes the first pump signal with the input signal to generate a first stage output signal; and
a second stage that receives a second pump signal, and mixes the second pump signal with the first stage output signal to generate an OFS stage output signal.

79. The optical frequency shifter of claim 76 where said input signal coupling structure comprises:
a set of n−1 beamsplitters disposed to split the output beams of n−1 preceding translation stages and provide a portion of the n−1 output beams the input port of the nth translation stage.

80. A method for synthesizing a plurality of optical frequencies comprising the steps of:
receiving an input signal having an input signal frequency;
performing a first translation of a frequency shift of Δ on the input signal to generate a first translated signal having a frequency translated from the input signal frequency by Δ;
performing a second translation of a frequency shift of 2Δ on both the input signal and the first translated signal to generate second and third translated signals translated from the input signal frequency by 2Δ and 3Δ; and
sequentially performing n subsequent translations, n being an integer equal to 3, . . . , N, with the nth translation translating the frequency of the input signal and all previously generated translated signals by a frequency shift of 2ⁿΔ to generate 2ⁿ translated signals translated from the input signal frequency by nΔ, n+1Δ, n+2Δ, . . . , 2ⁿ−2Δ, 2ⁿ−1Δ.

81. The method of claim 80 where said step of performing a translation comprises the steps of:
receiving first and second pump signals at first and second pump frequencies and at least one input signal, with the first and second pump frequencies having frequency values near a frequency value of the input signal;
generating second harmonics of the first and second pump signals to form first and second doubled pump signals having doubled first and second pump frequencies; and
mixing the input signal with the first doubled pump signal to form a first mixed signal and mixing the first mixed signal with the second doubled pump signal to generate an output signal shifted in frequency from the input signal by double the difference of the doubled first and second pump frequencies.

82. The method of claim 81 further comprising the steps of:
providing a first pump signal having the first pump frequency equal to a basic pump frequency; and
providing a second pump signal having a second pump frequency substantially equal to the sum of the base pump frequency and (½)Δ multiplied by 2 raised to the power of (n−1).

83. The method of claim 80 where said step of performing a translation comprises the steps of:
receiving first and second pump signals at first and second pump frequencies and at least one input signal, with the first and second pump frequencies having frequency values near about double the frequency value of the input signal; and
mixing the input signal with the first pump signal to form a first mixed signal and mixing the first mixed signal with the second pump signal to generate an output signal shifted in frequency from the input signal by the difference of the first and second pump frequencies.

84. An optical frequency shifter comprising:
a plurality of optical frequency translation stages, each stage for translating the frequency of an input signal by a frequency shift, with the frequency shift of a following stage equal about double the frequency shift of a preceding stage; and
an input signal coupling structure for coupling the input port of each optical frequency translation stage to the output ports of all optical frequency translation stages preceding the optical stage.
